(19) United States
(12) Patent Application Publication
(10) Pub. No.: US 2026/0081774 A1
(43) Pub. Date: Mar. 19, 2026

(54) AN APPARATUS, A METHOD OF OPERATING AN APPARATUS, AND A NON-TRANSITORY COMPUTER READABLE MEDIUM TO STORE COMPUTER-READABLE CODE FOR FABRICATION OF AN APPARATUS

(71) Applicant: ARM LIMITED, Cambridgeshire (GB)

(72) Inventors: Roberto Avanzi, Grasbrunn (DE); Andreas Lars Sandberg, Cambridge (GB); David Helmut Schall, Grasbrunn (DE); Ionut Alexandru Mihalcea, Cambridge (GB)

(73) Assignee: Arm Limited, Cambridge (GB)

(21) Appl. No.: 19/108,542

(22) PCT Filed: Jul. 19, 2023
(86) PCT No.: PCT/GB2023/051902

§ 371 Date: Mar. 4, 2025

(30) Foreign Application Priority Data
Sep. 7, 2022 (GB) 2213066.0

(51) Int. Cl. H04L 9/08

(52) U.S. Cl. CPC H04L 9/0891

(57) ABSTRACT

There is provided an apparatus provided with counter control circuitry to maintain counters associated with data items including: minor counters, middle counters, and a major counter. The apparatus is also provided with a memory protection unit configured, in response to a transfer of a data item from secure storage to off-chip storage, to modify a minor counter associated with the data item, and to encrypt the data item based on counters associated with the data item. The memory protection unit is also responsive to an overflowing minor counter, to perform a middle re-encryption process comprising modifying a middle counter associated with the data item and re-encrypting data items associated with the middle counter. The memory protection unit is also responsive to an overflowing middle counter, to perform a major re-encryption process comprising modifying the major counter, and re-encrypting each of the data items.

The present technique relates to an apparatus, a method of operating an apparatus, and a non-transitory computer readable medium to store computer-readable code for fabrication of an apparatus.

Some apparatuses are provided with memory protection circuitry arranged to perform an encryption process to encrypt data items in response to transfer of the data items from secure storage to off-chip storage.

According to some configurations there is provided an apparatus comprising:
counter control circuitry to maintain a plurality of counters associated with a plurality of data items, the plurality of counters including:
   a plurality of minor counters each associated with one of the plurality of data items;
   a plurality of middle counters each associated with a subset of the plurality of data items and a corresponding subset of the plurality of minor counters; and
   a major counter associated with the plurality of data items; and
a memory protection unit configured:
in response to a transfer of a data item of the plurality of data items from secure storage to off-chip storage, to modify a corresponding minor counter associated with the data item, and subsequently to encrypt the data item using an encryption process based on each of the plurality of counters associated with the data item;
in response to an overflowing minor counter of the plurality of minor counters, to perform a middle re-encryption process comprising modifying a middle counter associated with the overflowing minor counter and re-encrypting each of the subset of the plurality of data items associated with the middle counter using the encryption process; and
in response to an overflowing middle counter of the plurality of middle counters, to perform a major re-encryption process comprising modifying the major counter to indicate occurrence of the overflowing middle counter, and subsequently re-encrypting each of the plurality of data items using the encryption process.

According to some configurations there is provided a method of operating an apparatus, the method comprising:
maintaining a plurality of counters associated with a plurality of data items, the plurality of counters including:
   a plurality of minor counters each associated with one of the plurality of data items;
   a plurality of middle counters each associated with a subset of the plurality of data items and a corresponding subset of the plurality of minor counters; and
   a major counter associated with the plurality of data items;
in response to a transfer of a data item of the plurality of data items from secure storage to off-chip storage, modifying a corresponding minor counter associated with the data item, and subsequently encrypting the data item using an encryption process based on each of the plurality of counters associated with the data item;

in response to an overflowing minor counter of the plurality of minor counters, performing a middle re-encryption process comprising modifying a middle counter associated with the overflowing minor counter and re-encrypting each of the subset of the plurality of data items associated with the middle counter using the encryption process; and
in response to an overflowing middle counter of the plurality of middle counters, performing a major re-encryption process comprising modifying the major counter to indicate occurrence of the overflowing middle counter, and subsequently re-encrypting each of the plurality of data items using the encryption process.

According to some configurations there is provided a non-transitory computer readable medium to store computer-readable code for fabrication of an apparatus comprising:
counter control circuitry to maintain a plurality of counters associated with a plurality of data items, the plurality of counters including:
   a plurality of minor counters each associated with one of the plurality of data items;
   a plurality of middle counters each associated with a subset of the plurality of data items and a corresponding subset of the plurality of minor counters; and
   a major counter associated with the plurality of data items; and
a memory protection unit configured:
in response to a transfer of a data item of the plurality of data items from secure storage to off-chip storage, to modify a corresponding minor counter associated with the data item, and subsequently to encrypt the data item using an encryption process based on each of the plurality of counters associated with the data item;
in response to an overflowing minor counter of the plurality of minor counters, to perform a middle re-encryption process comprising modifying a middle counter associated with the overflowing minor counter and re-encrypting each of the subset of the plurality of data items associated with the middle counter using the encryption process; and
in response to an overflowing middle counter of the plurality of middle counters, to perform a major re-encryption process comprising modifying the major counter to indicate occurrence of the overflowing middle counter, and subsequently re-encrypting each of the plurality of data items using the encryption process.

The present techniques will be described further, by way of example only, with reference to configurations thereof as illustrated in the accompanying drawings, in which:

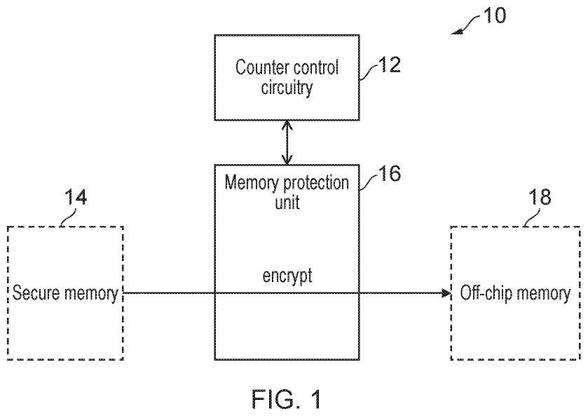

FIG. 1 schematically illustrates a data processing apparatus according to various configurations of the present techniques;

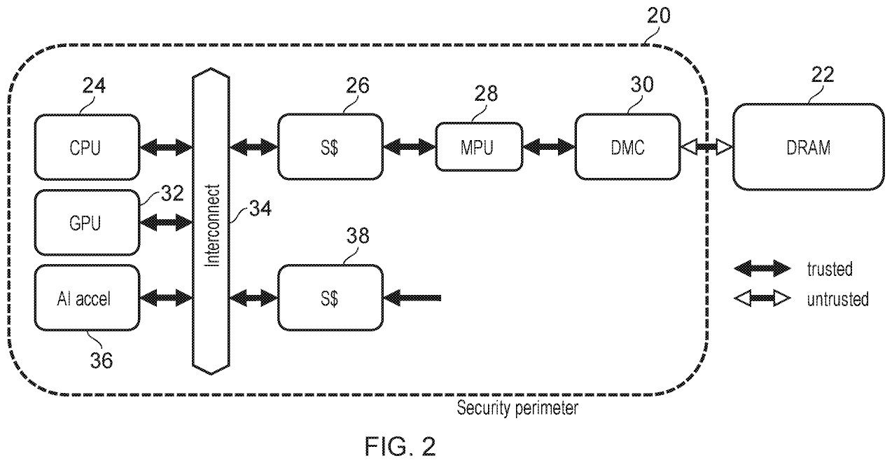

FIG. 2 schematically illustrates a data processing apparatus according to various configurations of the present techniques;

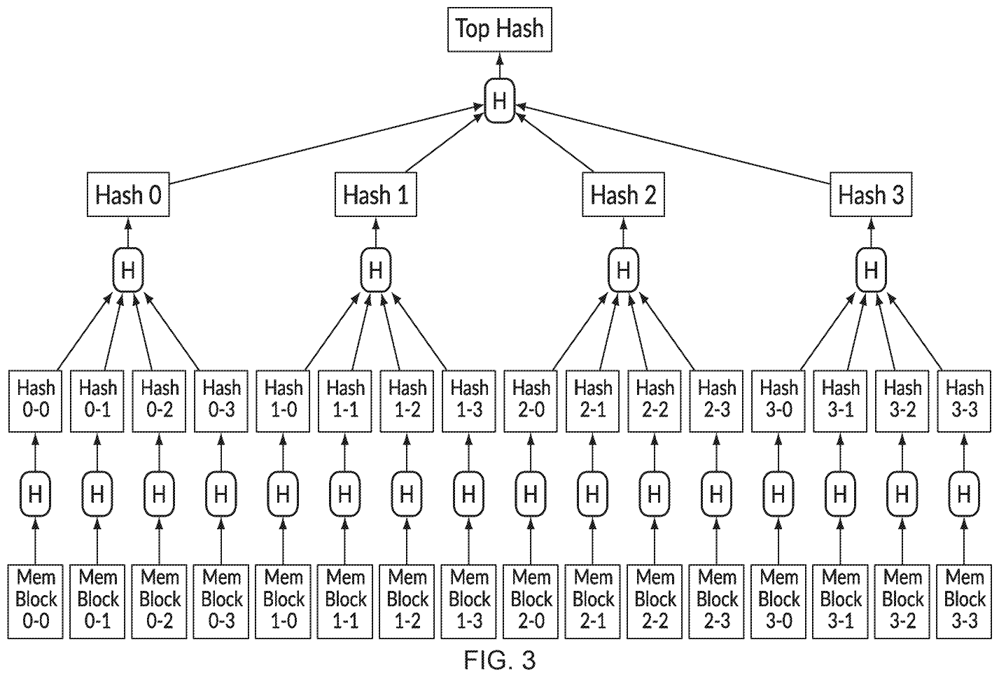

FIG. 3 schematically illustrates a data integrity tree according to various configurations of the present techniques;

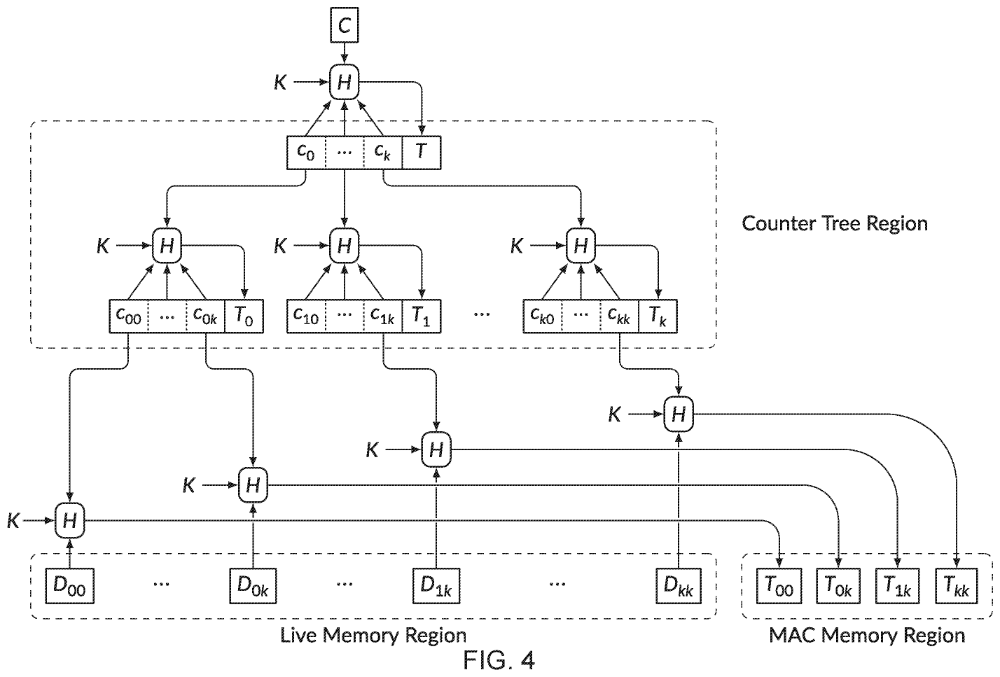

FIG. 4 schematically illustrates a data integrity tree according to various configurations of the present techniques;

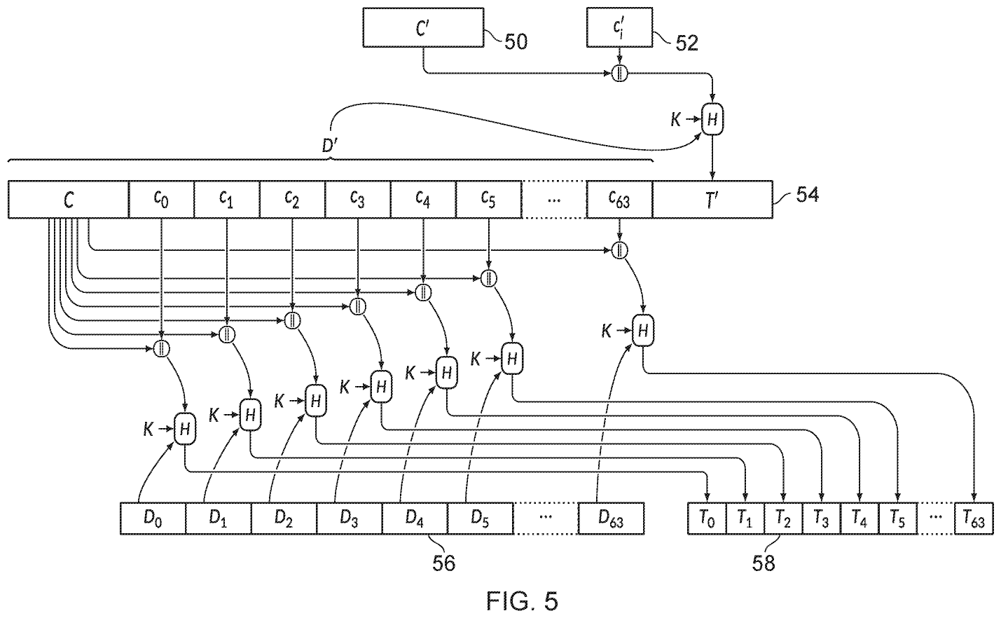

FIG. 5 schematically illustrates a data integrity tree according to various configurations of the present techniques;

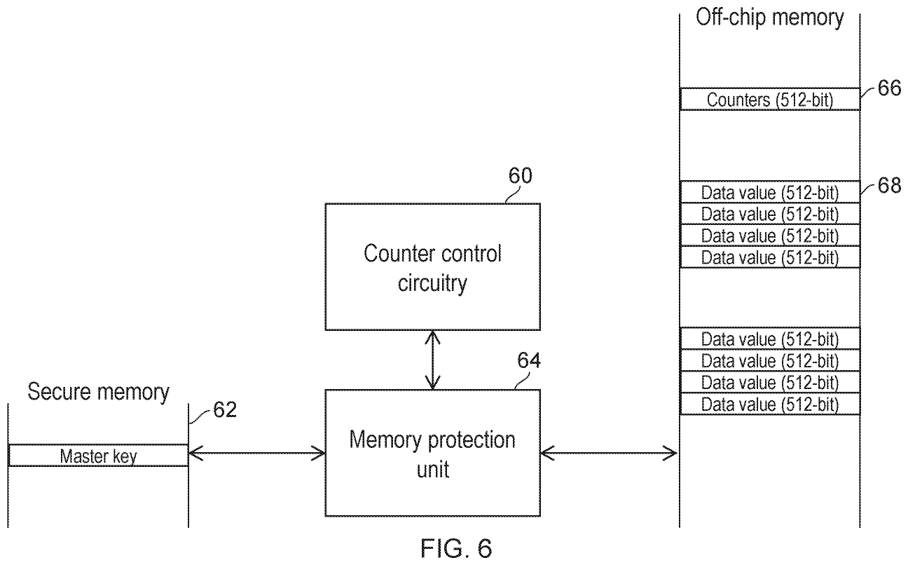

FIG. 6 schematically illustrates a data processing apparatus according to various configurations of the present techniques;

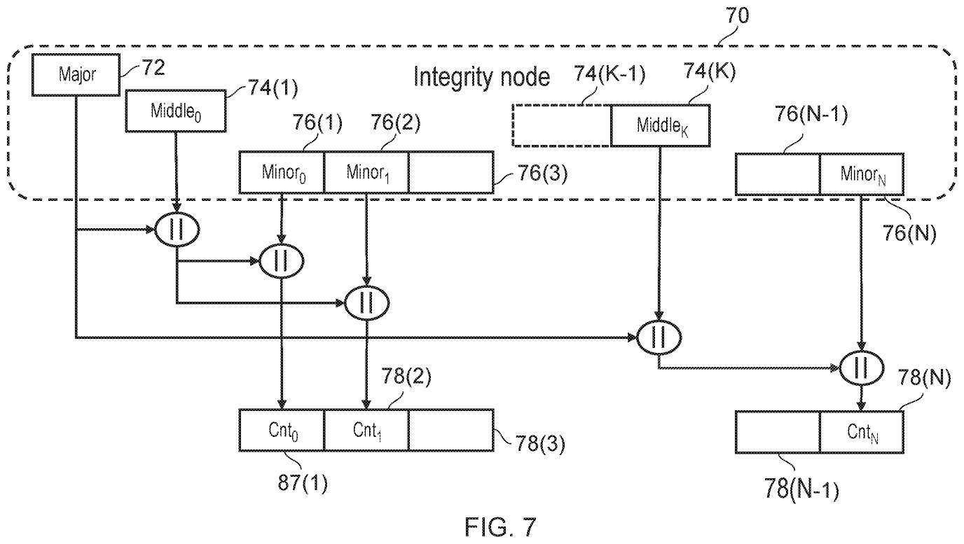

FIG. 7 schematically illustrates details of a data integrity tree according to various configurations of the present techniques;

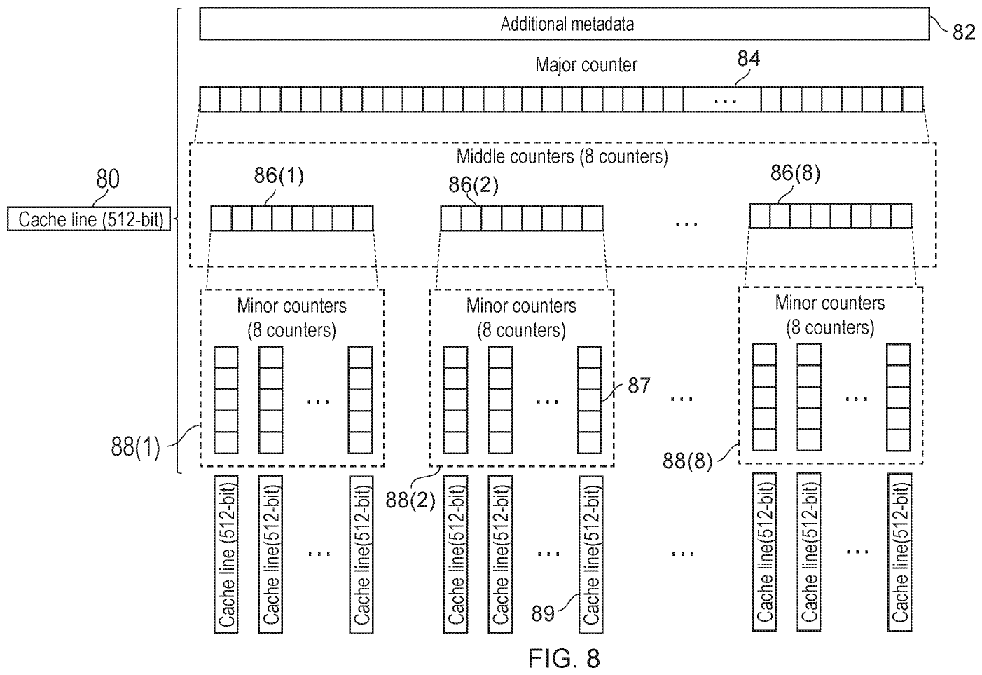

FIG. 8 schematically illustrates details of a data integrity tree according to various configurations of the present techniques;

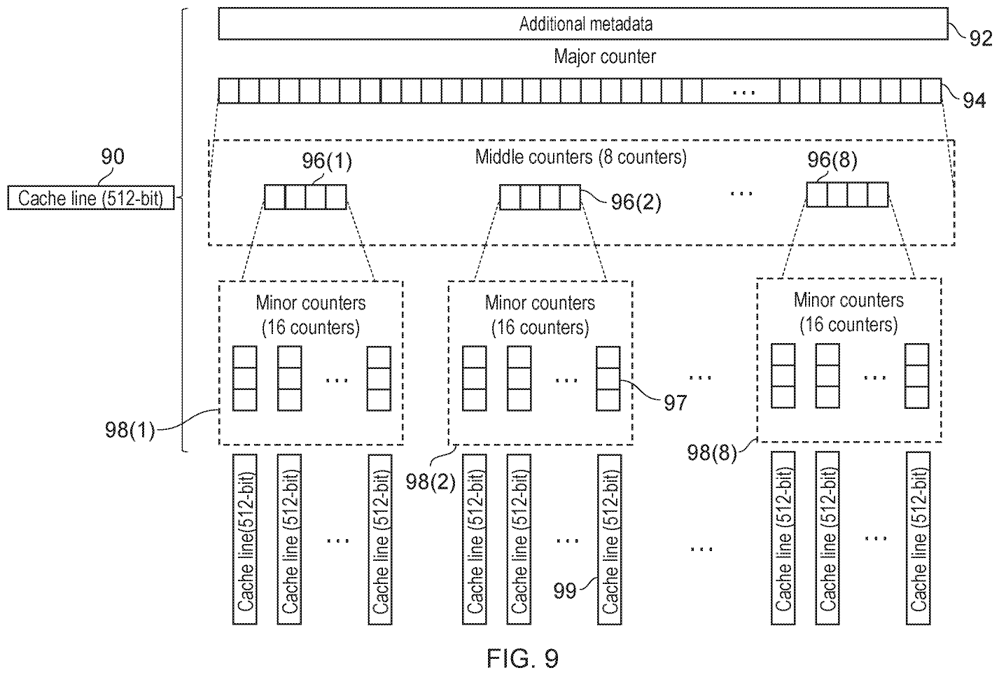

FIG. 9 schematically illustrates details of a data integrity tree according to various configurations of the present techniques;

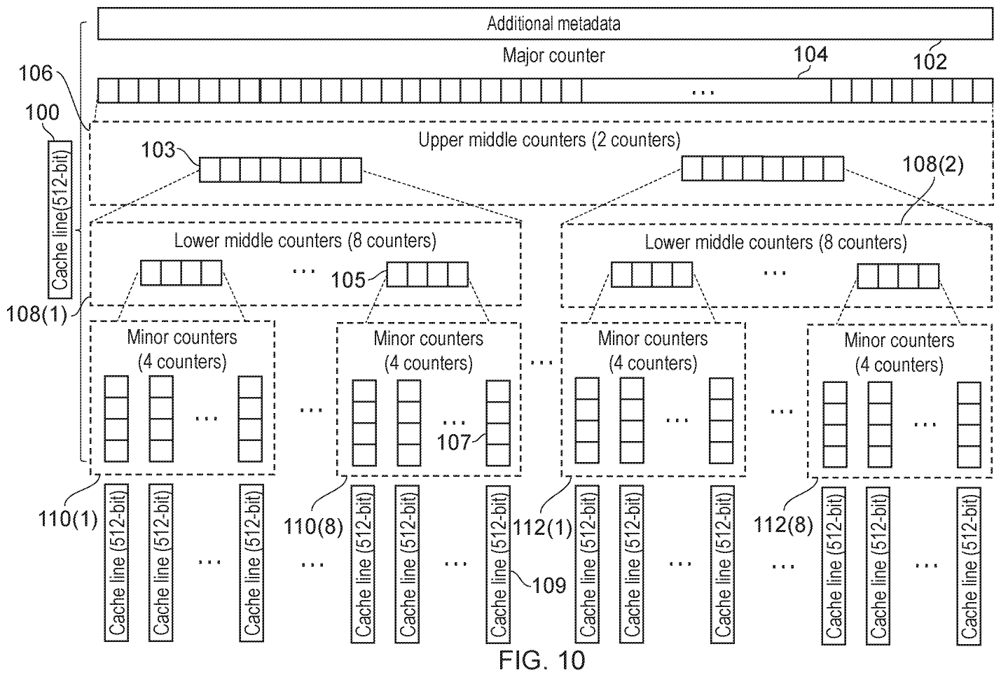

FIG. 10 schematically illustrates details of a data integrity tree according to various configurations of the present techniques;

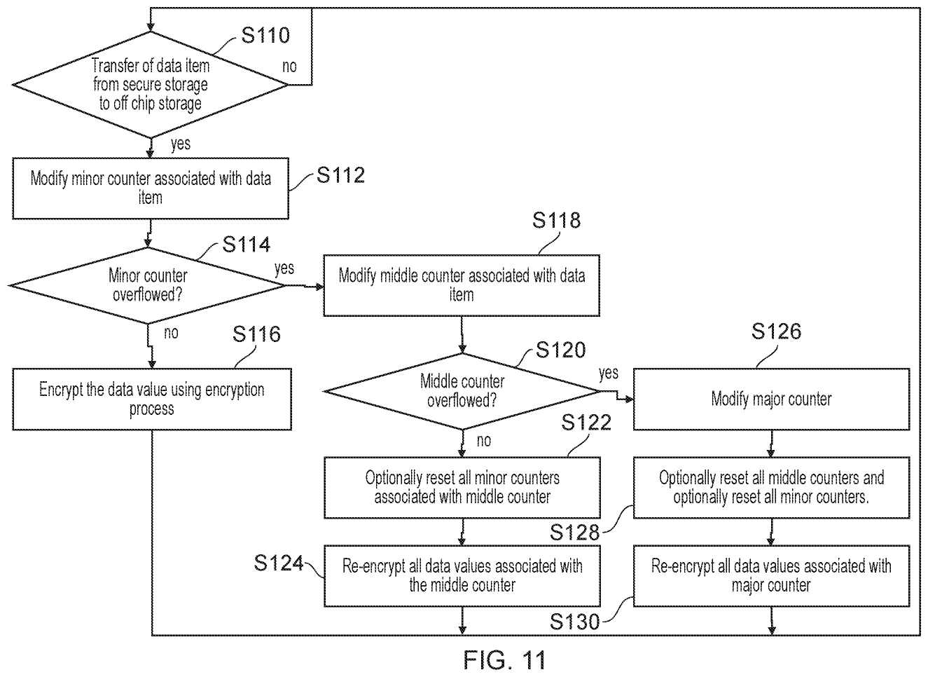

FIG. 11 schematically illustrates a sequence of steps taken by an apparatus according to various configurations of the present techniques; and

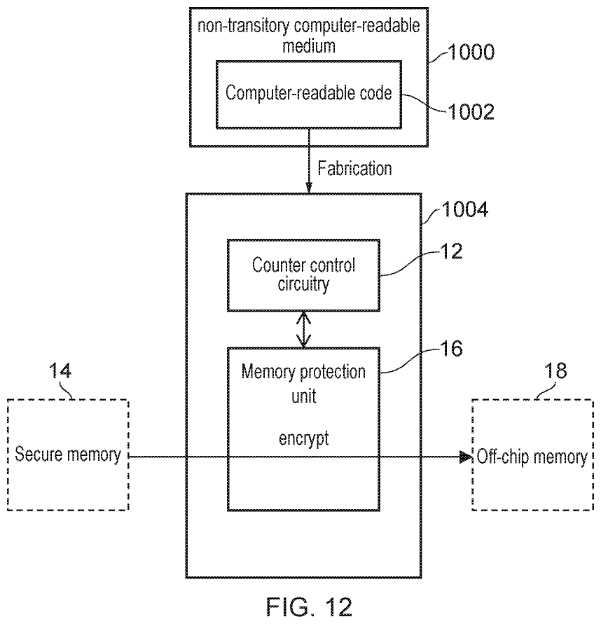

FIG. 12 schematically illustrates a data processing apparatus according to various configurations of the present techniques.

At least some configurations provide an apparatus comprising counter control circuitry to maintain a plurality of counters associated with a plurality of data items. The plurality of counters includes: a plurality of minor counters each associated with one of the plurality of data items, a plurality of middle counters each associated with a subset of the plurality of data items and a corresponding subset of the plurality of minor counters, and a major counter associated with the plurality of data items. The memory protection unit is arranged, in response to a transfer of a data item of the plurality of data items from secure storage to off-chip storage, to modify a corresponding minor counter associated with the data item, and subsequently to encrypt the data item using an encryption process based on each of the plurality of counters associated with the data item. The memory protection unit is arranged, in response to an overflowing minor counter of the plurality of minor counters, to perform a middle re-encryption process comprising modifying a middle counter associated with the overflowing minor counter and re-encrypting each of the subset of the plurality of data items associated with the middle counter using the encryption process. In addition, the memory protection unit is arranged, in response to an overflowing middle counter of the plurality of middle counters, to perform a major re-encryption process comprising modifying the major counter to indicate occurrence of the overflowing middle counter, and subsequently re-encrypting each of the plurality of data items using the encryption process.

In order to maintain integrity and security of data items stored in off-chip storage, some apparatuses perform an encryption process to protect the data items either from being read by an external entity or to provide assurance of the integrity of the data items, i.e., to allow the apparatus to verify that the data items have not been modified by an external entity. In particular, by encrypting the data items themselves based on an on-chip value, it is possible to prevent data items from being read. Alternatively, or in addition, by creating, as the encryption process, an encrypted hash of the data item (that is, for example, stored with the data item), the integrity of the data item can be determined by, at the time of reading the data item, transferring the data item from the off-chip storage to the secure storage, recomputing the encrypted hash of the data item and comparing it to the previously stored encrypted vale. If the data item has been modified, then the recomputed encrypted hash value will not match the stored hash value. Such an approach may be vulnerable to a replay attack in which an attacker attempts to work around such a system by resending previously observed data in order to fool the system into believing that falsified data is genuine.

In order to protect the data items, the apparatus is provided with counter control circuitry to maintain a plurality of counters. The plurality of counters is used as an input into the encryption process and are updated in response to a transfer of a data item being transferred to the off-chip storage. In this way, it is possible to mitigate against replay attacks because the counter values that are used will be different each time data is written to the off-chip storage. A consequence of such an approach is that a large number of counter values need to be stored and maintained. One approach to reducing the storage overhead associated with the counter values is to associate a single counter value with plural data items. This approach has the downside that, for each time the counter value is updated, each of the plurality of data items would have to be decrypted using the previous counter value and re-encrypted using the new counter value. The inventors have realised that, by providing the plurality of counters as different levels of counters including minor counters each associated with one of the plurality of data items (a single data item), middle counters each associated with a plurality of the minor counters and a corresponding plurality of data items, and major counters each associated with a plurality of the middle counters and a corresponding plurality of data items, it is possible to reduce the storage required per data item whilst avoiding the requirement to re-encrypt multiple data items on each access. The data items may be encrypted to generate message authentication codes (MACs) to be used to verify the integrity of the data items.

The provision of counters in this manner means that, for each of the data items that are protected by this mechanism there is provided at least a minor counter, a middle counter, and a major counter. When a minor counter is incremented, it is only the (single) data item that is associated with the minor counter that must be re-encrypted. Once the minor counter overflows (due to a particular data item being transferred from secure storage to off-chip storage), the middle counter that is associated with the data item is incremented. Because the encryption process for each data item is based on all counters associated with that data item, it is necessary to re-encrypt all data items that are associated with the middle counter. Similarly, once the middle counter overflows (due to a particular data item being transferred from secure storage to off-chip storage and causing the associated minor counter to also overflow), the major counter associated with the data item is incremented. Because the encryption process for each data item is based on all counters associated with that data item, it is necessary to re-encrypt all data items that are associated with the major counter. The provision of three layers of counters (minor, middle and major) provides for a highly flexible approach that allows for a sufficient number of counter values to be maintained and that does not require the re-encryption of all data items associated with the major counter each time any such data item is accessed.

In addition to the improved flexibility, using three layers of counters allows the overhead associated with the counters to be reduced. Considering the alternative of two layers of counters (minor and major), when a set number of bits are used, there are two options: either a small number of minor counters can be used or a small number of bits have to be provided for each minor counter. In the former case, the number of data items that can be associated with the set number of bits is small (equal to the number of minor counters), in the latter case, the major counter will increment frequently resulting in a memory intensive rewrite of all data items associated with the major counter. In the present invention, the provision of the middle counters enables a large number of minor counters to be provided. Because a large number of minor counters are provided, for the set number of bits, each of the minor counters will only have a small number of bits and could overflow frequently. An overflow of the minor counter causes the middle counter to increment which triggers a rewrite of the data items associated with the middle counter. Whilst this is more memory intensive than rewriting a single data item, it is less memory intensive than rewriting all data items associated with the major counter. By choosing the combined size of the middle and minor counters to be sufficiently large the frequency with which the major counter is incremented (major counter increments per minor counter increment) can be kept to a manageable level.

In some configurations the middle re-encryption process comprises, prior to re-encrypting each of the subset of the plurality of data items associated with the middle counter, resetting each of the corresponding subset of the plurality of minor counters associated with the middle counter. As a result, the lowest number of accesses required to cause a subsequent overflow of a minor counter associated with the middle counter is increased. In some alternative configurations the middle re-encryption process comprises retaining a current value of each of the corresponding subset of the plurality of minor counters associated with the middle counter.

In some configurations the major re-encryption process comprises, prior to re-encrypting each of the plurality of data items, resetting each of the plurality of middle counters. As a result, the lowest number of accesses required to cause a subsequent overflow of one of the plurality of middle counters is increased. In some alternative configurations the major re-encryption process comprises retaining a current value of each of the plurality of middle counters.

In some configurations the major re-encryption process comprises, prior to re-encrypting each of the plurality of data items, resetting each of the plurality of minor counters. As a result, the lowest number of accesses required to cause a subsequent overflow of one of the plurality of minor counters is increased, thereby increasing the number of accesses required to cause one of the plurality of middle counters to increase. In some alternative configurations the major re-encryption process comprises retaining a current value of each of the plurality of minor counters.

The size of a data item can be either fixed or variable. However, in some configurations each of the plurality of data items has a size corresponding to a size of a single cache line. A cache line is typically a smallest unit of data that is transferred between a the apparatus and the off-chip storage. Hence, providing counter control circuitry to maintain the minor counters at a cache line granularity reduces the implementation overhead.

In some configurations a total number of bits used to store the plurality of counters is fewer than or equal to a number of bits of a single cache line. Storing the plurality of counters in a single cache line means that all minor and middle counters that are associated with the major counter are retrieved from the off-chip storage in a single access and the counters necessary to perform the encryption and decryption processes for the data items associated with the plurality of counters can be performed without having to retrieve any further counters from the off-chip storage.

The minor, middle, and major counters can be provided as being of any size. However, in some configurations each of the plurality of minor counters is a 5-bit counter; and the plurality of middle counters comprises 8 middle counters and each of the 8 middle counters is an 8-bit counter. In such a configuration, a total of 2⁵ writes to a same data item are required to trigger an overflow of the minor counter associated with that same data item. Furthermore, a total of 2⁽⁵⁺⁸⁾ writes to the same data item are required to trigger an overflow of the middle counter associated with the same data item. As a result, an increment of the major counter is triggered infrequently and fewer memory intensive operations to rewrite all the data items associated with the major counter are required.

In some configurations, each of the plurality of minor counters is a 3-bit counter; and the plurality of middle counters comprises 8 middle counters and each of the 8 middle counters is a 4-bit counter. In such a configuration, a total of 2³ writes to a same data item are required to trigger an overflow of the minor counter associated with that same data item. Furthermore, a total of 2⁽³⁺⁴⁾ writes to the same data item are required to trigger an overflow of the middle counter associated with the same data item. Using this choice of sizes for the counters allows a greater number of data items to be associated with the counters for a fixed storage space, for example, in the single cache line.

The above techniques can be implemented for cache lines having any size. However, in some configurations, the number of bits of the single cache line is 512 bits. In such configurations, when each minor counter is a 5-bit counter and the plurality of middle counters comprises 8 8-bit counters, a total supported number of data items is 64 corresponding to 64 minor counters (one minor counter for each data item) with 8 minor counters associated with each middle counter. This requires 64×5=320 bits for the minor counters and 8×8=64 bits for the middle counters using a total of 384 bits. The remaining 128 bits are used for the major counter and (optionally) to store any additional metadata associated with the counters. Whilst it is theoretically possible to support 64 data items using only two layers of counters (minor and major), such an arrangement of counters would only allow for 6 bits per minor counter (assuming 128 bits to be left for the major counter and any additional metadata). As a result, in the absence of the middle counter, the major counter would be incremented once any of the minor counters has incremented 2⁶ times. Hence, the provision of the middle counter can be used to reduce the memory overhead.

In configurations in which the single cache line is 512 bits, and when each minor counter is 3 bits and the plurality of middle counters comprise 8 4-bit counters the plurality of counters can be associated with 128 data items with each of the middle counters associated with 16 of the minor counters. This requires 128×3=384 bits for the minor counters and 8×4=32 bits for theiddle counters resulting in a total of 416 bits. The remaining 96 bits are used for the major counter and (optionally) to store any additional metadata associated with the counters. Again, whilst it is theoretically possible to support 128 data items using only two layers of counters (minor and major), such an arrangement would only allow for 3 bits per minor counter and, as a result, the major counter would be incremented once any one of the minor counters has incremented 2³ times which would result in a large memory overhead that could quickly become prohibitive. Hence, the provision of the middle counter can be used to increase the number of data items that can be associated with a single 512-bit cache line. By providing counters associated with 128 data items in a single cache line rather than 64 data items in a single cache line, the amount of memory used to store the plurality of counters is halved. Considering a server storing 1.5 Tb of data with a minor counter provided for each cache line, the total memory required to store counters associated with this amount of data is reduced from 24 Gb where a 512-bit cache line is associated with 64 cache lines to 12 Gb where a 512-bit cache line is associated with 128 cache lines.

In some configurations the major counter is a 64-bit counter. The provision of a large counter for the major counter reduces the likelihood of a same set of counter values being used for encryption. A 64-bit counter provides 2⁶⁴ possible values which, even when combined with relatively small minor and middle counters results in a range of encryption values that are unlikely to be repeated.

The counters can be implemented in a number of different ways. In some configurations each of the plurality of counters is implemented as one of: a linear feedback shift register, wherein overflowing corresponds to the linear feedback shift register reaching a predetermined state; a non-linear feedback shift register, wherein overflowing corresponds to the non-linear feedback shift register reaching a predetermined state; and a binary counter, wherein overflowing corresponds to the binary counter exceeding a predetermined value. A linear/non-linear feedback shift register is a shift register whose input is a linear/non-linear function of its previous state. Such shift registers have a finite number of possible states and eventually repeat. The linear/non-linear feedback shift registers are considered to have overflowed when they reach a particular state, in which case, the next counter of the plurality of counters is incremented. Where binary counters are used, they are considered to overflow when a particular value is exceeded. In some configuration the particular value is a maximal value, in which case the binary counter is reset to a minimal value and the next counter of the plurality of counters is incremented. In other configurations, the particular value is a value other than the maximal value that is set in the counter control circuitry. In some configurations, different counter levels use different counter implementations. For example, in some configurations the minor counters could be linear feedback shift registers and both the middle and major counters could be binary counters. In some alternative configurations all of the counters could be implemented as a same type of counter.

In some configurations the encryption process is performed using, as an encryption key, a combination of each of the plurality of counters associated with the data item. For each data item there is an associated minor counter, an associated middle counter and an associated major counter. In some configurations, the encryption key is a hash of the combination of each of the plurality of counters associated with the data item. The encryption process may also use a secure key stored in the secure storage.

In some configurations the combination is a concatenation of each of the plurality of counters associated with the value. The minor counter, the middle counter and the major counter associated with the data item can be concatenated in any order and can be concatenated before or after a hash has been applied to the counters.

In some configurations the combination is an addition of values stored in each of the plurality of counters associated with the data item. In some configurations each of the plurality of counters is hashed before the hashed counter values are added together. In some configurations a combination of concatenation and addition is used to combine the counters to generate the encryption key. In some configurations, the minor counter and the middle counter associated with the data item are concatenated and the result is added to the major counter.

The plurality of counters is not limited to three layers. In some configurations, the plurality of middle counters comprises a plurality of layers of middle counters arranged as part of a hierarchical tree structure comprising the major counter, the plurality of layers of middle counters, and the plurality of minor counters; each middle counter of one of the plurality of layers is associated with a plurality of lower level counters associated with a sequentially lower layer of the hierarchical structure; and the memory protection unit is responsive to an overflowing lower level counter of the corresponding subset of the plurality of lower level counters, to perform a next level re-encryption process comprising modifying a next level counter associated with the overflowing lower level counter and re-encrypting each of the subset of the plurality of data items associated with the next level counter. The separation of the middle counters into a plurality of layers of middle counters provides a further level of flexibility. In such configurations each data item would be associated with a minor counter, a major counter and one middle counter from each of the layers of middle counters.

In some configurations the memory protection engine and the secure storage are integrated on a same chip. The memory protection engine and the secure storage may be implemented as discrete logical blocks that are integrated as distinct units within the same chip. Alternatively, a single logical block can be provided that provides the function of both the secure storage and the memory protection engine. In some configurations the counter control circuitry is also integrated onto the same chip and may be provided as a distinct circuit or as a combined logical block that functions as one or more of the secure storage and the memory protection engine. By integrating the memory protection engine and the secure storage onto the same chip, additional security is provided as it is difficult to falsify information in order to perform an attack within the chip.

In some configurations the plurality of counters are stored in the secure storage. Storing the plurality of counters in secure storage avoids the need to encrypt or otherwise protect the plurality of counters. In some alternative configurations, the plurality of counters are stored off-chip and are encrypted using a master key stored in the secure storage. This approach avoids the need for provision of large regions of secure storage for the plurality of counters.

In some configurations each data item is associated with a single minor counter, at least one middle counter and the major counter. Where a plurality of layers of middle counters are provided each data item is associated with one middle counter from each of the plurality of layers of middle counters.

In some configurations the memory protection unit is configured to decrypt an encrypted data item transferred from the off-chip storage to the secure storage using a decryption process based on each of the plurality of counters associated with the encrypted data item. In this way, the memory protection unit ensures that the unencrypted data is stored in the secure storage and only an encrypted version of the data is stored in the off-chip storage.

In some configurations the plurality of counters corresponds to a single node in a data integrity tree, the data integrity tree comprising a plurality of nodes each storing a corresponding plurality of counters and at least one node of the plurality of nodes is an intermediate node associated with a corresponding set of data items each data item comprising a further node of the plurality of nodes. A data integrity tree comprises a plurality of nodes arranged in a tree like structure with a single root node, (optionally) one or more intermediate levels of nodes and leaf nodes. Each of the plurality of nodes comprises a plurality of counters. The data items associated with the counters of the root node and the (optional) intermediate levels of nodes are lower level nodes of the data integrity tree. The data items associated with the counters of the leaf node are data items to be protected. In this way each data item is protected by counters comprised in a leaf node of the plurality of nodes, each of the nodes of the data integrity tree is protected by counters comprised in a layer of nodes that is closer to the root node. The counters of the root node are stored in secure storage. Thus, each node of the plurality of nodes is protected by the nodes that are one layer closer to the root node. Arranging the plurality of counters within a node of a data integrity tree provides the means to increase the number of data items protected whilst only retaining one set of counters in the secure storage.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Particular configurations of the present techniques will now be described with reference to the accompanying figures.

FIG. 1 schematically illustrates an apparatus 10 according to some configurations of the present techniques. The apparatus 10 comprises counter control circuitry 12, and a memory protection unit 16. The counter control circuitry 12 is configured to maintain and update a plurality of counters. The counters comprise minor counters, middle counters and major counters. The memory protection unit 16 is arranged to control encryption of data being transferred from the secure memory 14 to the off-chip memory 18. Each data item is associated with a minor counter, at least one middle counter, and the major counter. The encryption of data by the memory protection unit 16 is performed based on the counters associated with that data item. In addition, when an item of data is transferred from the secure memory 14 to the off-chip memory 18, the memory protection unit 14 is arranged to modify the counters associated with the data item and to perform the encryption of the data item using an encryption process based on the plurality of counters associated with that data item.

FIG. 2 schematically illustrates further details of an apparatus according some configurations of the present techniques. The data processing apparatus is provided with a secure region 20 surround by a security perimeter. Circuitry that is comprised within the secure region 20 is considered to be trusted and circuitry that outside of the secure region 20 is considered to be vulnerable to attack and therefore untrusted. For example, DRAM 22 is off-chip storage that is outside of the secure region 20 and, potentially, could be tampered with without the knowledge of components within the secure region. The secure region comprises dynamic memory controller 30 (DMC), a memory protection unit 28 (MPU) which includes integrated counter control circuitry, caches 26, 28 (which are secure storage located in the secure region 20), an interconnect 34 and master devices including CPU 24, GPU 32 and AI accelerator 36. Data items are transferred between the DRAM 22 and the cache 26 via the memory controller 30 and the memory protection unit 28. The data items are transferred when requested by one of the master devices and may be cached in one or more higher levels of cache associated with the CPU 24, the GPU 32, or the AI accelerator 36. As described above, data that is stored within the secure region 20 does not need to be protected via an encryption process. On the other hand, data that is stored outside of the secure region 20, for example, in the DRAM 22 should be protected using an encryption process.

FIG. 3 schematically illustrates the concept of a data integrity tree used to protect data items in a sequence of memory blocks (Mem Block 0-0 to Mem Block 3-3). Each of the memory blocks is stored in off-chip storage. In order to validate that the data stored in the memory blocks has not been tampered with, a hash (Hash 0-0 to Hash 3-3) is generated for each of the memory blocks at the time of storage. When the data is read, the corresponding hash can also be read and compared against a newly generated version of the hash which is based on the data being read. In this way it can be determined if either the hash or the memory block has been modified during storage. For example, if Mem Block 1-2 is modified during storage then a hash generated from the data in Mem Block 1-2 will not match Hash 1-2 which was generated before the storage of Mem Block 1-2. Using such an approach can provide some assurance that the data in the memory blocks has not been modified. However, there is no guarantee from this data alone, that there has not been a modification to both the data in the memory block and the corresponding hash. Therefore, as a next level of the data integrity tree, a number of higher level hashes are formed based on the combination of the hashes generated from the data blocks. For example, Hash 0 is generated as a hash of Hash 0-0, Hash 0-1, Hash 0-2, and Hash 0-3; Hash 1 is generated as a hash of Hash 1-0, Hash 1-1, Hash 1-2, and Hash 1-3; Hash 2 is generated as a hash of Hash 2-0, Hash 2-1, Hash 2-2, and Hash 2-3; and Hash 3 is generated as a hash of Hash 3-0, Hash 3-1, Hash 3-2, and Hash 3-3. Thus, if the upper level hashes (Hash 0, Hash 1, Hash 2, and Hash 3) are stored at a same time as the hashes (Hash 0-0 to Hash 3-3) and the corresponding memory blocks, then, at a time of reading the data in the memory blocks, the integrity of the data read from the memory block (Memory Block 1-2 for example) can be achieved by re-computing the hash and comparing it against the previously stored hash (Hash 1-2 in the above example), similarly, the integrity of the hash value that is stored can be determined by re-computing the upper level hash and comparing it against the upper hash value (Hash 1 in this case) that was stored at the same time as Hash 1-0 to Hash 1-3 and the corresponding memory blocks. In the above example, the stored value of Hash 1 is compared against a hash generated from Hash 1-0, Hash 1-1, Hash 1-2, and Hash 1-3. As with the hashes (Hash 0-0 to Hash 3-3) this process cannot verify that each of the data block, the corresponding hash value, and the upper level hash value have not all been modified. Therefore, a top level hash is generated based on the upper level hashes (Hash 0, Hash 1, Hash 2, and Hash 3). The top hash can be recomputed at the time at which the data is read and can be compared against a stored value of the top hash to verify the integrity of the upper level hashes. In order to ensure that the top level hash is also not modified, the top hash is stored in secure storage. In this way it is possible to validate the integrity of data items stored in the memory blocks.

FIG. 4 schematically illustrates an alternative integrity tree for verifying the integrity of stored data. Rather than storing a tree of hash values that are generated from data items of from hash values that are stored further from the root of the integrity tree, the integrity tree stores sets of counters. The counters (denoted c in the figure) at each level are stored in association with a MAC (denoted T in FIG. 4). The MAC is generated from the associated counters and a higher level counter. Starting at the top of the tree, a single top level counter C is stored in secure storage. A top level node of the counter tree region of the integrity tree comprises a plurality of counters c₀. . . cₖ which are each associated with a next level of the counter tree region. The top level node of the counter tree also stores a MAC T which is generated from a hash of the counters c₀. . . cₖ , the top level counter C, and a secret key K. In this way, the counters c₀. . . cₖ of the top level node can be validated by regenerating the MAC T and comparing it against the stored T. If any of the counters c₀. . . cₖ have changed, or if the MAC T has changed then the comparison will fail. At a next level of the counter tree region of the integrity tree, each node comprises a plurality of next level counters c₀₀. . . cₖₖ where counters cᵢ₀. . . cᵢₖ are associated with counter cᵢ of the top level node of the integrity tree. Each node (i) at the next level of the counter tree region of the data integrity tree also comprises a MAC Tᵢ for i in the range 0. . . k which is generated from a hash of the counters cᵢ₀. . . cᵢₖ combined with the counter cᵢ from the top level node and the secret key K. In this way, the counters cᵢ₀. . . cᵢₖ of node i can be validated by regenerating the MAC Tᵢ and comparing it against the stored Tᵢ. If any of the counters cᵢ₀. . . cᵢₖ, the MAC Tᵢ or the counter cᵢ of the top level node has changed, the comparison will fail. Each counter of the next level of the counter tree region is associated with data Dᵢⱼ for i in the range 0. . . k and j in the range 0. . . k and a corresponding MAC Tᵢⱼ. Each MAC Tᵢⱼ is generated from a hash of the data Dᵢⱼ in combination with the counter cᵢⱼ and the secret key. In this way, the data Dᵢⱼ can be validated by regenerating the MAC Tᵢⱼ and comparing it against the stored Tᵢⱼ. An integrity tree comprising a counter tree region can be made robust to replay attacks by incrementing (or otherwise modifying) counters before the data items are written. Modification of a counter, for example, counter c₁₀ would require the MACs T₁₀, and T₁ to be recomputed. Modification of a counter of the upper level node, for example, c₀, would require the MACS T and T₀ to be recomputed.

FIG. 5 schematically illustrates the use of a plurality of levels of counter within a single node of a counter tree in accordance with various configurations of the present techniques. In the illustrated configuration the node of the counter tree 54 comprises a plurality of counters including a single major counter C and 64 minor counters cⱼ for j in the range 0 to 63. Each of the 64 minor counters is associated with corresponding data Dⱼ and a corresponding MAC Tⱼ generated as a hash of the data Dⱼ combined with minor counter cⱼ, major counter C, and the secret key K. As discussed, the provision of the counters as a set of minor counters combined with a single major counter enables the provision of a greater number of counters for the same number of bits within a node of the integrity tree. Integrity of the data Dⱼ can be determined on reading by re-computing the MAC Tⱼ and comparing it against the stored MAC Tⱼ. The counters C and cⱼ are associated with a MAC T′ which is calculated based on a hash of the counters C and cⱼ in combination with the secret key K and the major and minor counters C′ and c′ᵢ from a next level node closer to the root of the integrity tree. As in the case of FIG. 4, when data Dⱼ is written to the off-chip storage the associated minor counter cⱼ is modified to indicate mitigate against replay attacks. When the counter cⱼ is modified, the MAC Tⱼ must be recomputed for consistency with the minor counter cⱼ. In addition, the MAC T′ must be recomputed for consistency with the minor counter cⱼ. In the event that the minor counter cⱼ overflows, the major counter C is incremented. When C is incremented each of the MACs T₀. . . T₆₃ must be recomputed for consistency with the modified major counter. In addition the MAC T′ must be recomputed for consistency with the major counter C. Thus, a greater number of data items can be associated with a single node of the counter tree in this way. However, when a data item is modified a sufficient amount of times that the minor counter associated with that data item is modified, then the counter overflows and, as a result, the MACs associated with each data item that is associated with the minor counter must be recomputed.

FIG. 6 schematically illustrates the layout of counters 66 and data values 68 in the off-chip memory. The data values 68 and the counters 66 are stored as 512-bit cache lines and are transferred to and from the secure memory by the memory protection unit 64. During transfer, the counters 66 are maintained by the counter control circuitry 60. The data values 68 may comprise both the data value and the calculated MAC or, alternatively, the data values and the corresponding MACs can be stored in different portions of the off-chip memory. Counters 66 associated with the data values 68 can be stored in a specific region of the off-chip memory or, alternatively, counters associated with a page of memory can be stored at a location aligned to the page boundary.

FIG. 7 schematically illustrates the plurality of counters within a single node of an integrity tree according to some configurations of the present techniques. The plurality of counters comprises a major counter 72, a plurality of middle counters 74 and a plurality of minor counters 76. Each of the minor counters 76 is associated with a data item (not shown). Each of the data items is associated with a single minor counter 76, a single middle counter 74 and the major counter 72. In the illustrated configuration the encryption of a single data item is based on a combination of the major counter 72, the middle counter 74 and the minor counter 76 that is associated with that data item. In particular count Cnt₀ 87(1) is associated with a first data item and is generated from a combination of the major counter 72, middle counter 74(1) and minor counter 76(1); count Cnt₁ 87(2) is associated with a first data item and is generated from a combination of the major counter 72, middle counter 74(1) and minor counter 76(2); and count Cnt_{N} 87(N) is associated with a first data item and is generated from a combination of the major counter 72, middle counter 74(K) and minor counter 76(N). The combination operation is a concatenation of the data items. In alternative configurations, the combination can be achieved through addition or any other arithmetic operation.

FIG. 8 schematically illustrates a lay out of counters associated with some configurations of the present techniques. The counters comprise major counter 84, eight middle counters 86, each of which is an 8-bit counter, and sixty-four minor counters arranged into groups of eight minor counters 88, each of the minor counters is a 5-bit counter. The plurality of counters is stored in a single 512-bit cache line 80 in addition to the additional metadata 82. The counters are used to generate MACs for a set of data item cache lines. Each of the cache lines is a 512-bit cache line. Each of the data item cache lines is associated with a single minor counter 88, a single middle counter 86 and the major counter 84. Each middle counter 86 is associated with a group of eight minor counters 88. In this way a total of sixty-four cache lines can be covered by a plurality of counters stored within a single cache line. The counters are used in performing an encryption process of the data items, for example, to generate MACs that are used to verify that the data items stored in off-chip storage have not been modified. Each time a cache line is written, for example, cache line 89, the memory protection unit is responsive to the cache line 89 being written and increments the corresponding minor counter 87. The memory protection unit is arranged, in response to the modification to the minor counter 87 to perform an encryption process to generate a MAC based on the minor counter 87, the middle counter 86(2) that is associated with the cache line 89, and the major counter 84. The memory protection unit is responsive to the modification to the minor counter 87 causing the minor counter 87 to overflow, to modification the middle counter 86(2) and to perform a middle encryption process to encrypt each of the cache lines associated with the middle counter 86(2) and the minor counters 88(2) based on the modified middle counter 86(2). Similarly, the memory protection unit is responsive to the modification of the middle counter 86(2) causing the middle counter 86(2) to overflow to modify the major counter 84 and to perform a major encryption process to encrypt each of the cache lines associated with the major counter based on the modified major counter.

FIG. 9 schematically illustrates a lay out of counters associated with some configurations of the present techniques. The counters comprise major counter 94, eight middle counters 96, each of which is a 5-bit counter, and one hundred and twenty-eight minor counters arranged into groups of sixteen minor counters 98, each of the minor counters is a 3-bit counter. The plurality of counters is stored in a single 512-bit cache line 90 in addition to the additional metadata 92. The counters are used to generate MACs for a set of data item cache lines. Each of the cache lines is a 512-bit cache line. Each of the data item cache lines is associated with a single minor counter 98, a single middle counter 96 and the major counter 94. Each middle counter 96 is associated with a group of sixteen minor counters 98. In this way a total of one hundred and twenty-eight cache lines can be covered by a plurality of counters stored within a single cache line. The counters are used in performing an encryption process of the data items, for example, to generate MACs that are used to verify that the data items stored in off-chip storage have not been modified. Each time a cache line is written, for example, cache line 99, the memory protection unit is responsive to the cache line 99 being written and increments the corresponding minor counter 97. The memory protection unit is arranged, in response to the modification to the minor counter 97 to perform an encryption process to generate a MAC based on the minor counter 97, the middle counter 96(2) that is associated with the cache line 99, and the major counter 94. The memory protection unit is responsive to the modification to the minor counter 97 causing the minor counter 97 to overflow, to modification the middle counter 96(2) and to perform a middle encryption process to encrypt each of the cache lines associated with the middle counter 96(2) and the minor counters 98(2) based on the modified middle counter 96(2). Similarly, the memory protection unit is responsive to the modification of the middle counter 96(2) causing the middle counter 96(2) to overflow to modify the major counter 94 and to perform a major encryption process to encrypt each of the cache lines associated with the major counter based on the modified major counter.

FIG. 10 schematically illustrates a lay out of counters associated with some configurations of the present techniques. The counters comprise major counter 104, two upper layer middle counters 106, each of which is an 8-bit counter, sixteen lower layer middle counters 108 arranged as two groups of middle layer counters and sixty-four minor counters arranged into groups of four minor counters 110, 112. A first group of minor counters 110 is associated with lower middle counters 108(1) and a first of the upper middle counters 106, and a second group of minor counters 112 is associated with lower middle counters 108(2) and a second of the upper middle counters 106. Each of the minor counters is a 4-bit counter. The plurality of counters is stored in a single 512-bit cache line 100 in addition to the additional metadata 102. The counters are used to generate MACs for a set of data item cache lines. Each of the cache lines is a 512-bit cache line. Each of the data item cache lines is associated with a single minor counter of one of the groups of minor counters 110, 112, a single lower middle counter 108, a single upper middle counter of the group of upper middle counters 106, and the major counter 104. In this way a total of sixty-four cache lines can be covered by a plurality of counters stored within a single cache line. The counters are used in performing an encryption process of the data items, for example, to generate MACs that are used to verify that the data items stored in off-chip storage have not been modified. Each time a cache line is written, for example, cache line 109, the memory protection unit is responsive to the cache line 109 being written and increments the corresponding minor counter 107. The memory protection unit is arranged, in response to the modification to the minor counter 107 to perform an encryption process to generate a MAC based on the minor counter 107, the lower middle counter 105 that is associated with the cache line 109, the upper middle counter 103 that is associated with the cache line 109, and the major counter 104. The memory protection unit is responsive to the modification to the minor counter 107 causing the minor counter 107 to overflow, to modify the lower middle counter 105 and to perform a lower middle encryption process to encrypt each of the cache lines associated with the lower middle counter 105 and the minor counters 110(8) based on the modified middle counter 105. The memory protection unit is responsive to the modification to the lower middle counter 105 causing the lower middle counter 105 to overflow, to modify the upper middle counter 103 and to perform an upper middle encryption process to encrypt each of the cache lines associated with the upper middle counter 103, including all cache lines associated with lower middle counters 108(1) and minor counters 110. Similarly, the memory protection unit is responsive to the modification of the upper middle counter 103 causing the upper middle counter 103 to overflow to modify the major counter 104 and to perform a major encryption process to encrypt each of the cache lines associated with the major counter based on the modified major counter.

FIG. 11 schematically illustrates a sequence of steps carried out by the memory protection unit. Flow begins at step S110 where it is determined whether data is being transferred from secure storage to off chip storage. If no then flow returns to step S110. If, at step S110, it is determined that data is being transferred from secure storage to off chip storage then flow proceeds to step S112 where the memory protection unit modifies a minor counter that is associated with the data item. Flow then proceeds to step S114 where it is determined whether the minor counter has overflowed as a result of the modification at step S112. It, at step S114, it is determined that the minor counter has not overflowed then flow proceeds to step S116, where the data item is encrypted using an encryption process. The encryption process generates a MAC based on the data item and the counters, including the modified minor counter, that are associated with that data item. Flow then returns to step S110. If, at step S114, it was determined that a minor counter had overflowed, then flow proceeds to step S118. At step S118, the memory protection unit modifies the middle counter associated with the data item and flow proceeds to step S120. At step S120, it is determined whether the middle counter has overflowed. If, at step S120, it was determined that the middle counter had not overflowed then flow proceeds to step S112 where (optionally) all the minor counters associated with the middle counter that had overflowed are reset. Flow then proceeds to step S124 where the memory protection unit re-encrypts all the data values that are associated with the middle counter that was modified to generate new MACs for each of the data items associated with the middle counters. Flow then returns to step S110. If, at step S120, it was determined that the middle counter had overflowed then flow proceeds to step S126, where the major counter is modified. Flow then proceeds to step S128, where (optionally) all the middle counters and all minor counters are reset. Flow then proceeds to step S130, where all data values associated with the major counter are re-encrypted based on the modified major, minor, and middle counters to generate new MACs that are consistent with the modified counter values. Flow then returns to step S110.

FIG. 12 schematically illustrates a non-transitory computer-readable medium comprising computer readable code for fabrication of a data processing apparatus according to various configurations of the present techniques. Fabrication is carried out based on computer readable code 1002 that is stored on a non-transitory computer-readable medium 1000. The computer-readable code can be used at one or more stages of a semiconductor design and fabrication process, including an electronic design automation (EDA) stage, to fabricate an integrated circuit comprising the apparatus embodying the concepts. The fabrication process involves the application of the computer readable code 1002 either directly into one or more programmable hardware units such as a field programmable gate array (FPGA) to configure the FPGA to embody the configurations described hereinabove or to facilitate the fabrication of an apparatus implemented as one or more integrated circuits or otherwise that embody the configurations described hereinabove. The fabricated design 1004 comprises counter control circuitry 12 and memory protection unit 16 arranged to perform encryption and decryption in relation to the transfer of data items between secure memory 14 and off-chip storage 18 as described in reference to FIG. 1.

In brief overall summary there is provided an apparatus provided with counter control circuitry to maintain counters associated with data items including: minor counters, middle counters, and a major counter. The apparatus is also provided with a memory protection unit configured, in response to a transfer of a data item from secure storage to off-chip storage, to modify a minor counter associated with the data item, and to encrypt the data item based on counters associated with the data item. The memory protection unit is also responsive to an overflowing minor counter, to perform a middle re-encryption process comprising modifying a middle counter associated with the data item and re-encrypting data items associated with the middle counter. The memory protection unit is also responsive to an overflowing middle counter, to perform a major re-encryption process comprising modifying the major counter, and re-encrypting each of the data items.

In the present application, the words “configured to . . .” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative configurations have been described in detail herein with reference to the accompanying drawings, it is to be understood that the invention is not limited to those precise configurations, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

1. An apparatus comprising:
counter control circuitry to maintain a plurality of counters associated with a plurality of data items, the plurality of counters including:
a plurality of minor counters each associated with one of the plurality of data items;
a plurality of middle counters each associated with a subset of the plurality of data items and a corresponding subset of the plurality of minor counters; and
a major counter associated with the plurality of data items; and
a memory protection unit configured:
in response to a transfer of a data item of the plurality of data items from secure storage to off-chip storage, to modify a corresponding minor counter associated with the data item, and subsequently to encrypt the data item using an encryption process based on each of the plurality of counters associated with the data item;
in response to an overflowing minor counter of the plurality of minor counters, to perform a middle re-encryption process comprising modifying a middle counter associated with the overflowing minor counter and re-encrypting each of the subset of the plurality of data items associated with the middle counter using the encryption process; and
in response to an overflowing middle counter of the plurality of middle counters, to perform a major re-encryption process comprising modifying the major counter to indicate occurrence of the overflowing middle counter, and subsequently re-encrypting each of the plurality of data items using the encryption process.

2. The apparatus of claim 1, wherein the middle re-encryption process comprises, prior to re-encrypting each of the subset of the plurality of data items associated with the middle counter, resetting each of the corresponding subset of the plurality of minor counters associated with the middle counter.

3. The apparatus of claim 1, wherein the major re-encryption process comprises, prior to re-encrypting each of the plurality of data items, resetting at least one of:
each of the plurality of middle counters; and/or each of the plurality of minor counters.

4. (canceled)

5. The apparatus of claim 1, wherein each of the plurality of data items has a size corresponding to a size of a single cache line.

6. The apparatus of claim 1, wherein a total number of bits used to store the plurality of counters is fewer than or equal to a number of bits of a single cache line.

7. The apparatus of claim 6, wherein:
each of the plurality of minor counters is a 5-bit counter; and
the plurality of middle counters comprises 8 middle counters and each of the 8 middle counters is an 8-bit counter.

8. The apparatus of claim 6, wherein:
each of the plurality of minor counters is a 3-bit counter; and
the plurality of middle counters comprises 8 middle counters and each of the 8 middle counters is a 4-bit counter.

9. The apparatus of claim 6, wherein the number of bits of the single cache line is 512 bits.

10. The apparatus of claim 1, wherein the major counter is a 64-bit counter.

11. The apparatus of claim 1, wherein each of the plurality of counters is implemented as one of:
a linear feedback shift register, wherein overflowing corresponds to the linear feedback shift register reaching a predetermined state;
a non-linear feedback shift register, wherein overflowing corresponds to the non-linear feedback shift register reaching a predetermined state; and
a binary counter, wherein overflowing corresponds to the binary counter exceeding a predetermined value.

12. The apparatus of claim 1, wherein the encryption process is performed using, as an encryption key, a combination of each of the plurality of counters associated with the data item.

13. The apparatus of claim 12, wherein the combination is one of:
a concatenation of each of the plurality of counters associated with the value; or
an addition of values stored in each of the plurality of counters associated with the data item.

14. (canceled)

15. The apparatus of claim 1, wherein:
the plurality of middle counters comprises a plurality of layers of middle counters arranged as part of a hierarchical tree structure comprising the major counter, the plurality of layers of middle counters, and the plurality of minor counters;
each middle counter of one of the plurality of layers is associated with a plurality of lower level counters associated with a sequentially lower layer of the hierarchical structure; and
the memory protection unit is responsive to an overflowing lower level counter of the corresponding subset of the plurality of lower level counters, to perform a next level re-encryption process comprising modifying a next level counter associated with the overflowing lower level counter and re-encrypting each of the subset of the plurality of data items associated with the next level counter.

16. The apparatus of claim 1, wherein the memory protection engine and the secure storage are integrated on a same chip.

17. The apparatus of claim 1, wherein the plurality of counters are one of:
stored in the secure storage; or
stored off-chip and are encrypted using a master key stored in the secure storage.

18. (canceled)

19. The apparatus of claim 1, wherein each data item is associated with a single minor counter, at least one middle counter and the major counter.

20. The apparatus of claim 1, wherein the memory protection unit is configured to decrypt an encrypted data item transferred from the off-chip storage to the secure storage using an decryption process based on each of the plurality of counters associated with the encrypted data item.

21. The apparatus of claim 1, wherein the plurality of counters corresponds to a single node in a data integrity tree, the data integrity tree comprising a plurality of nodes each storing a corresponding plurality of counters and at least one node of the plurality of nodes is an intermediate node associated with a corresponding set of data items each data item comprising a further node of the plurality of nodes.

22. A method of operating an apparatus, the method comprising:
maintaining a plurality of counters associated with a plurality of data items, the plurality of counters including:
a plurality of minor counters each associated with one of the plurality of data items;
a plurality of middle counters each associated with a subset of the plurality of data items and a corresponding subset of the plurality of minor counters; and
a major counter associated with the plurality of data items;
in response to a transfer of a data item of the plurality of data items from secure storage to off-chip storage, modifying a corresponding minor counter associated with the data item, and subsequently encrypting the data item using an encryption process based on each of the plurality of counters associated with the data item;
in response to an overflowing minor counter of the plurality of minor counters, performing a middle re-encryption process comprising modifying a middle counter associated with the overflowing minor counter and re-encrypting each of the subset of the plurality of data items associated with the middle counter using the encryption process; and
in response to an overflowing middle counter of the plurality of middle counters, performing a major re-encryption process comprising modifying the major counter to indicate occurrence of the overflowing middle counter, and subsequently re-encrypting each of the plurality of data items using the encryption process.

23. A non-transitory computer readable medium to store computer-readable code for fabrication of an apparatus comprising:
counter control circuitry to maintain a plurality of counters associated with a plurality of data items, the plurality of counters including:
a plurality of minor counters each associated with one of the plurality of data items;
a plurality of middle counters each associated with a subset of the plurality of data items and a corresponding subset of the plurality of minor counters; and
a major counter associated with the plurality of data items; and
a memory protection unit configured:
in response to a transfer of a data item of the plurality of data items from secure storage to off-chip storage, to modify a corresponding minor counter associated with the data item, and subsequently to encrypt the data item using an encryption process based on each of the plurality of counters associated with the data item;
in response to an overflowing minor counter of the plurality of minor counters, to perform a middle re-encryption process comprising modifying a middle counter associated with the overflowing minor counter and re-encrypting each of the subset of the plurality of data items associated with the middle counter using the encryption process; and
in response to an overflowing middle counter of the plurality of middle counters, to perform a major re-encryption process comprising modifying the major counter to indicate occurrence of the overflowing middle counter, and subsequently re-encrypting each of the plurality of data items using the encryption process.
